(19) United States
(12) Patent Application Publication
(10) Pub. No.: US 2018/0044205 A1
(43) Pub. Date: Feb. 15, 2018

(54) DEVICE FOR REMOVING MICROPARTICLES CONTAINED IN WATER AND ULTRAPURE-WATER PROUCTION AND SUPPLY SYSTEM

(71) Applicants: KURITA WATER INDUSTRIES LTD., Tokyo (JP); ASAHI KASEI KABUSHIKI KAISHA, Tokyo (JP)

(72) Inventors: Takahiro KAWAKATSU, Tokyo (JP); Hideaki IINO, Tokyo (JP); Takeo FUKUI, Tokyo (JP); Masayuki KANEDA, Tokyo (JP); Daisuke SATO, Tokyo (JP)

(21) Appl. No.: 15/552,434

(22) PCT Filed: Feb. 22, 2016
(86) PCT No.: PCT/JP2016/054999

§ 371 Date: Aug. 21, 2017

(30) Foreign Application Priority Data
Feb. 23, 2015 (JP) 2015-033002

(51) Int. Cl. C02F 1/44; B01D 61/14; B01J 47/12; B01J 41/13; C08J 5/22; B01D 71/72; B01D 69/02

(52) U.S. Cl. CPC C02F 1/444; B01D 71/72; B01D 61/142; B01D 61/145; B01D 61/147; B01D 69/02; B01J 41/13; C08J 5/2256; B01J 47/12; C02F 2103/04

(57) ABSTRACT

In a subsystem or water-feed path located upsteam of a use point in an ultrapure water production/supply process, fine particles having a particle diameter of 50 nm or less, in particular 10 nm or less are highly removed. A device for removing fine particles in water has a membrane filtration device including a microfiltration membrane or an ultrafiltration membrane having a weak cationic functional group. The microfiltration membrane or the ultrafiltration membrane having a weak cationic functional group is preferred to have a polyketone film with the weak cationic functional group. Negatively-charged particles in water are adsorbed by the weak cationic functional group and can thus be removed.

### TECHNICAL FIELD

The present invention relates to a device for removing microparticles including nanoparticles contained in water in an ultrapure-water production process. The present invention relates to a device for removing microparticles including nanoparticles contained in water which is suitable as a device for removing submicroscopic particles having a size of 50 nm or less or, in particular, 10 nm or less at a high removal ratio, the device being disposed in a subsystem or a water-feed path included in an ultrapure-water production and supply system which is located upstream of a point of use.

The present invention also relates to an ultrapure-water production and supply system that includes the above-described device for removing microparticles including nanoparticles contained in water.

### BACKGROUND ART

Ultrapure-water production and supply systems used in a semiconductor production process or the like typically have the structure illustrated in FIG. 1, in which an ultrafiltration membrane (UF membrane) device 17 for the removal of microparticles is disposed at the rear end of a subsystem 3 in order to remove nanometer-sized microparticles. There has also been an attempt to remove microparticles having a further small size at a high removal ratio by arranging a mini-subsystem that serves as a point-of-use polisher immediately upstream of a cleaning machine used for cleaning semiconductors and electronic materials, the mini-subsystem including a UF membrane device for the removal of microparticles which is disposed at the rear end of the mini-subsystem or by arranging a UF membrane device for the removal of microparticles immediately upstream of a nozzle of the cleaning machine at a point of use.

Recently, the control over the microparticles contained in water has been increasingly tightened due to the development of semiconductor production processes. International Technology Roadmap for Semiconductors (ITRS) requests that the certified value for the number of microparticles having a size of more than 11.9 nm being less than 1,000 particle/L (control value: less than 100 particle/L) be achieved by the year 2019.

The following technologies have been proposed to remove impurities contained in water, such as microparticles, at a high removal ratio and increase the purity of the water produced with an ultrapure-water production system.

Patent Literature 1 describes, a technology in which viable bacteria and microparticles are removed with an electrodeionization device disposed in the subsystem. Although a continuous operation of the electrodeionization device requires the permeation of the removed substance through an ion-exchange membrane included in the device, the microparticles are not capable of permeating through the ion-exchange membrane. Therefore, it is not possible to use the electrodeionization device for removing the microparticles.

Patent Literature 2 describes a technology in which a membrane separation unit is disposed in any of the components of an ultrapure-water supply apparatus, that is, namely, a pretreatment device, a primary pure water device, a secondary pure water device (i.e., the subsystem) or a recovery device, and a reverse osmosis membrane that has been treated such that the elution of amine can be reduced is disposed downstream of the membrane separation unit. Although it is possible to remove the microparticles with a reverse osmosis membrane, it is not preferable to use a reverse osmosis membrane for the following reasons.

It is necessary to increase pressure for operating a reverse osmosis membrane. The amount of water that permeates through the membrane is small, that is, about 1 m³/m²/day at a pressure of 0.75 MPa. Since the amount of water treated with current systems that uses a UF membrane is 7 m³/m²/day at a pressure of 0.1 MPa, which is 50 times or more the amount of water that permeates through a reverse osmosis membrane, it is necessary to use a reverse osmosis membrane having a considerably large area for treating an amount of water which is comparable to the amount of water treated with a UF membrane. In addition, it is necessary to drive a booster pump for using a reverse osmosis membrane, which may cause, for example, the generation of new microparticles and metals.

Patent Literature 3 describes a technology in which a functional material or a reverse osmosis membrane that includes an anionic functional group is disposed downstream of a UF membrane included in an ultrapure water line. The functional material or the reverse osmosis membrane that includes an anionic functional group is provided for reducing the amount of amines and not suitable for removing the microparticles having a size of 10 nm or less, which are to be removed in the present invention. In addition, it is not preferable to use a reverse osmosis membrane as in Patent Literature 2.

Patent Literature 4 describes a technology in which a reverse osmosis membrane device is disposed upstream of a UF membrane device located at the rear end of the subsystem. However, this technology has the same problem as in Patent Literature 2.

Patent Literature 5 describes a technology in which the particles are removed through a prefilter included in a membrane module constituting an ultrapure-water production line. Since it is an object of Patent Literature 5 to remove particles having a size of 0.01 mm or more, it is not possible to remove microparticles having a size of 10 nm or less, which are to be removed in the present invention.

Patent Literature 6 describes a technology in which water treated with an electrodeionization device is filtered through a UF-membrane filtration device including a filtration membrane that is not modified with an ion-exchange group and the permeate is treated with a membrane filtration device including an MF membrane modified with an ion-exchange group. Patent Literature 6 describes only examples of the ion-exchange group, which are cation-exchange groups such as a sulfonic group and an iminodiacetic acid group. Patent Literature 6 describes nothing about the types of the ion-exchange group and the targets that can be removed with the respective types of the ion-exchange group, although the definition of ion-exchange groups include anion-exchange groups.

Patent Literature 7 describes a technology in which an anion-adsorption membrane device is disposed downstream of a UF membrane device included in the subsystem, and the results of tests in which silica was used as a target to be removed are described therein. Patent Literature 7 does not describe the types of the anion-exchange group and the sizes of the microparticles. Since it is commonly known that the removal of ionic silica requires a strong-anion-exchange group (DIAION: Manual of Ion Exchange Resins and Synthetic Adsorbent, Volume 1, Mitsubishi Chemical Corporation, p. 15), it is considered that a membrane including a strong-anion-exchange group is used in Patent Literature 7.

Patent Literatures 8 and 9 describe the use of polyketone membranes modified with various functional groups as a membrane constituting a separator included in a capacitor, a battery, or the like. Patent Literature 9 describes the use of the polyketone membrane as a filter for water treatment. It is not suggested in Patent Literatures 8 and 9 that, among the modified polyketone membranes, in particular, a polyketone membrane modified with weakly cationic functional group is suitably used in an ultrapure-water production and supply system for removing submicroscopic particles having a size of 10 nm or less.

Patent Literature 10 describes a porous polyketone membrane including one or more functional groups selected from the group consisting of a primary amino group, a secondary amino group, a tertiary amino group, and a quaternary ammonium salt and having a negative-ion-exchange capacity of 0.01 to 10 milliequivalent/g. It is described in Patent Literature 10 that the above porous polyketone membrane is capable of efficiently removing impurities such as microparticles, gels, and viruses in the fields of the production of semiconductors and electronic components, biomedicines, chemicals, and food manufacture. It is also described in Patent Literature 10 that the 10-nm microparticles and anionic particles smaller than the pores of the porous membrane may be removed.

However, it is not descried in Patent Literature 10 that the porous polyketone membrane may be used in an ultrapure-water production process. Patent Literature 10 describes that both a strongly cationic quaternary ammonium salt and a weakly cationic amino group can be equivalently used as a functional group introduced to the porous polyketone membrane. Patent Literature 10 does not describe the impacts of changing the type (e.g., cation strength) of the functional group on the production of ultrapure water.

Patent Literature 1: Japanese Patent No. 3429808

Patent Literature 2: Japanese Patent No. 3906684

Patent Literature 3: Japanese Patent No. 4508469

Patent Literature 4: JP H5-138167 A

Patent Literature 5: Japanese Patent No. 3059238

Patent Literature 6: JP 2004-283710 A

Patent Literature 7: JP H10-216721 A

Patent Literature 8: JP 2009-286820 A

Patent Literature 9: JP 2013-76024 A

Patent Literature 10: JP 2014-173013 A

As described above, there has not been proposed a device for removing the microparticles contained in water which is capable of removing submicroscopic particles having a size of 50 nm or less or, in particular, 10 nm or less from water at a high removal ratio and which is suitably used in an ultrapure-water production and supply system.

### SUMMARY OF INVENTION

It is an object of the present invention to provide a device for removing microparticles including nanoparticles contained in water which is suitable as a device for removing submicroscopic particles having a size of 50 nm or less, in particular, 10 nm or less from water at a high removal ratio, the device being disposed in a subsystem or a water-feed path included in an ultrapure-water production and supply system which is located upstream of a point of use and an ultrapure-water production and supply system that includes the above-described device for removing microparticles including nanoparticles contained in water.

The inventor of the present invention found that using a microfiltration membrane (MF membrane) or a UF membrane including a weakly cationic functional group enables submicroscopic particles including nanoparticles having a size of 50 nm or less or, in particular, 10 nm or less to be removed at a high removal ratio and that using a polyketone membrane including a tertiary amino group, which is the weakly cationic functional group, or using the polyketone membrane in combination with an MF or UF membrane that does not include an ion-exchange group may further increase the microparticle removal ratio.

The present invention was made on the basis of the above-described findings. The summary of the present invention is as follows.

[1] A device for removing microparticles contained in water in a process for producing ultrapure water, the device comprising a membrane filtration unit including a microfiltration or ultrafiltration membrane including a weakly cationic functional group.

[2] The device for removing microparticles contained in water according to [1], wherein the microfiltration or ultrafiltration membrane including a weakly cationic functional group is prepared by introducing a weakly cationic functional group to a polyketone membrane.

[3] The device for removing microparticles contained in water according to [1] or [2], wherein the weakly cationic functional group is a tertiary amino group.

[4] The device for removing microparticles contained in water according to any one of [1] to [3], the device further comprising another membrane filtration unit disposed upstream or downstream of the membrane filtration unit including the microfiltration or ultrafiltration membrane including a weakly cationic functional group, the other membrane filtration unit including a microfiltration or ultrafiltration membrane that does not include an ion-exchange group.

[5] The device for removing microparticles contained in water according to any one of [1] to [4], wherein the microparticles are nanoparticles having a size of 10 nm or less.

[6] The device for removing microparticles contained in water according to any one of [1] to [5], the device being disposed in a subsystem included in an ultrapure-water production apparatus, the subsystem producing ultrapure water from primary pure water; in a water-feed path through which the ultrapure water is fed from the subsystem to a point of use; or at the point of use.

[7] An ultrapure-water production and supply system comprising an ultrapure-water production apparatus including a subsystem that produces ultrapure water from primary pure water; a water-feed path through which the ultrapure water is fed from the subsystem to a point of use; and the device for removing microparticles contained in water according to any one of [1] to [6], the device being disposed in the subsystem or the water-feed path.

### Advantageous Effects of Invention

According to the present invention, it is possible to remove submicroscopic particles including nanoparticles having a size of 50 nm or less or, in particular, 10 nm or less from water at a high removal ratio in an ultrapure-water production process.

The device for removing microparticles including nanoparticles contained in water according to the present invention is particularly suitable as a microparticle-removal device that performs a final treatment in a subsystem or a water-feed path included in an ultrapure-water production and supply system which is located upstream of a point of use. An ultrapure-water production and supply system that includes the device for removing microparticles including nanoparticles contained in water according to the present invention enables high-purity ultrapure water from which the microparticles have been removed at a high removal ratio to be fed to a point of use.

### BRIEF DESCRIPTION OF DRAWINGS

FIG. 1 is a system diagram illustrating an example of an ultrapure-water production and supply system.

### DESCRIPTION OF EMBODIMENTS

Embodiments of the present invention are described in detail below.

A device for removing microparticles including nanoparticles contained in water according to the present invention includes a membrane filtration unit (i.e., a membrane filter) including an MF or UF membrane including a weakly cationic functional group. It is possible to remove microparticles contained in water by passing the water to be treated through the membrane filtration unit to perform membrane filtration.

Since microparticles contained in water are negatively charged, the MF or UF membrane including a cationic functional group is capable of efficiently removing the microparticles contained in water by adsorbing and capturing the microparticles on the cationic functional group included in the membrane.

Among cationic functional groups, using a strongly cationic functional group is more advantageous in order to remove the negatively charged microparticles than using a weakly cationic functional group. However, it is not preferable to use a strongly cationic functional group, because, as described in Test Example IV-2 below, using a strongly cationic functional group may increase the amount of TOC components in the permeate as a result of the desorption of the strongly cationic functional group which may occur depending on water quality. Accordingly, an MF or UF membrane including a weakly cationic functional group is used in the present invention.

Examples of the weakly cationic functional group include a primary amino group, a secondary amino group, and a tertiary amino group. The MF or UF membrane may include only one selected from the above weakly cationic functional groups or may include two or more selected from the weakly cationic functional groups.

Among the weakly cationic functional groups, a tertiary amino group is preferable because it has a high cationic strength and is chemically stable.

Although a quaternary ammonium salt and a tertiary amino group are considered to be equal in Patent Literature 10 as described above, it is not preferable to use a quaternary ammonium group because it is a strongly cationic functional group, which is poor in chemical stability, and may contaminate ultrapure water by desorption as described in Test Example IV below.

In general, weakly anionic ionic substances contained in water, such as silica and boron, can be removed with a strong-anion-exchange resin included in the subsystem. Since the above ionic substances are not to be removed with the device for removing microparticles contained in water in an ultrapure-water production process according to the present invention, it is not necessary to introduce a strongly cationic functional group in order to remove these ionic substances.

The chemical stabilities of an amino group and an ammonium group, which are cationic functional groups, have been described in terms of the service temperatures of anion-exchange resins including the groups. A strong-anion-exchange resin including a quaternary ammonium group has a service temperature of 60° C. or less in the OH-form. A weak-anion-exchange resin including a tertiary amino group has a service temperature of 100° C. or less (DIAION: Manual of Ion Exchange Resins and Synthetic Adsorbent, Volume 2, Mitsubishi Chemical Corporation, II-4, DIAION: Manual of Ion Exchange Resins and Synthetic Adsorbent, Volume 2, Mitsubishi Chemical Corporation, II-8). The performance of a strong-anion-exchange resin degrades with time. The salt splitting capacity of a strong-anion-exchange resin significantly changes compared with the change in the total ion-exchange capacity of the strong-anion-exchange resin. This means that a quaternary ammonium group is changed into a tertiary amino group as a result of the desorption of an alkyl group from the quaternary ammonium group (DIAION: Manual of Ion Exchange Resins and Synthetic Adsorbent, Volume 1, Mitsubishi Chemical Corporation, pp. 92-93). This is also clear from the results described in Example V below.

For the above reasons, an MF or UF membrane including a weakly cationic functional group, such as a tertiary amino group, is used in the present invention.

The MF or UF membrane may be composed of any material including a weakly cationic functional group. Examples of such an MF or UF membrane include a polyketone membrane, a mixed cellulose ester membrane, a polyethylene membrane, a polysulfone membrane, a polyether sulfone membrane, a polyvinylidene fluoride membrane, and a polytetrafluoroethylene membrane. A polyketone membrane is preferable because it has a large surface opening ratio, which enables a high flux to be achieved even at a low pressure, and enables a weakly cationic functional group to be readily introduced to the MF or UF membrane by chemical modification as described below.

The polyketone membrane is a porous polyketone membrane containing 10% to 100% by mass polyketone which is a copolymer of carbon monoxide with one or more olefins and may be produced by a publicly known method (e.g., JP 2013-76024 A or WO 2013-035747 A).

The MF or UF membrane including a weakly cationic functional group captures and removes the microparticles contained in water due to the electrical adsorptive activity thereof. Although the size of pores formed in the MF or UF membrane may be larger than the size of the microparticles that are to be removed, excessively large pores of the MF or UF membrane may reduce the efficiency of removal of the microparticles. On the other hand, excessively small pores of the MF or UF membrane may disadvantageously increase the pressure required by membrane filtration. Accordingly, when an MF membrane is used, the size of pores of the MF membrane is preferably about 0.05 to about 0.2 μm. When a UF membrane is used, the molecular weight cut-off of the UF membrane is preferably about 5000 to about 1 million.

The shape of the MF or UF membrane is not limited; a hollow fiber membrane, a flat membrane, and the like, which are commonly used in the field of the production of ultrapure water, may be used.

The weakly cationic functional group may be directly introduced to a polyketone membrane or the like that constitutes the MF or UF membrane by chemical modification. The weakly cationic functional group may also be introduced to the MF or UF membrane as a result of a compound or ion-exchange resin including the weakly cationic functional group being deposited on the MF or UF membrane.

Examples of the method for producing a porous membrane that serves as the MF or UF membrane including a weakly cationic functional group include, but are not limited to, the following methods. The following methods may be used in combination of two or more.

(1) Directly introduce the weakly cationic functional group to the porous membrane by chemical modification.

For example, one of the methods for introducing a weakly cationic amino group to a polyketone membrane by chemical modification is to chemically react the polyketone membrane with a primary amine. It is preferable to use a multifunctional amine, such as a diamine, a triamine, a tetraamine, or a polyethyleneimine, which includes a primary amine (e.g., ethylenediamine, 1,3-propanediamine, 1,4-butanediamine, 1,2-cyclohexanediamine, N-methylethylenediamine, N-methylpropanediamine, N,N-dimethylethylenediamine, N,N-dimethylpropanediamine, N-acetylethylenediamine, isophoronediamine, or N,N-dimethylamino-1,3-propanediamine), because it enables the formation of a number of active sites. It is more preferable to use N,N-dimethylethylenediamine, N,N-dimethylpropanediamine, N,N-dimethylamino-1,3-propanediamine, or polyethyleneimine in order to introduce a tertiary amine to the polyketone membrane.

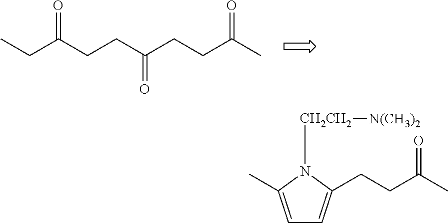

(2) Use two porous membranes and interpose a weak-anion-exchange resin (i.e., a resin including the weakly cationic functional group), which may be pulverized as needed, therebetween.

(3) Fill the inside of a porous membrane with the particles of the weak-anion-exchange resin. For example, the weak-anion-exchange resin is added to a porous-membrane-forming solution, and a membrane including the particles of the weak-anion-exchange resin is formed using the solution.

(4) Deposit a compound containing the weakly cationic functional group, such as a tertiary amine, on the porous membrane or coat the porous membrane with the compound by immersing the porous membrane in a tertiary amine solution or by passing the tertiary amine solution through the porous membrane. Examples of the compound containing the weakly cationic functional group, such as a tertiary amine, include N,N-dimethylethylenediamine, N,N-dimethylpropanediamine, N,N-dimethylamino-1,3-propanediamine, polyethyleneimine, amino-group-containing poly(meth)acrylic acid ester, and amino-group-containing poly(meth)acrylamide.

(5) Introduce the weakly cationic functional group, such as a tertiary amino group, to the porous membrane composed of polyethylene or the like by graft polymerization.

(6) Polymerize a styrene monomer including a halogenated alkyl group in which the halogenated alkyl group has been replaced with the weakly cationic functional group, such as tertiary amino group, and form the resulting polymer into a membrane by phase separation or electrospinning in order to prepare a porous membrane including the weakly cationic functional group, such as a tertiary amino group.

The amount of weakly cationic functional group included in the MF or UF membrane including a weakly cationic functional group is preferably, but not limited to, an amount such that the increase in the capability of the membrane to remove the microparticles defined below is 10 to 10000.

<Increase in Capability to Remove Microparticles>

The microparticle removal ratio R_{O} of a porous membrane prepared by, for example, any of the above methods (1) to (6) to which the weakly cationic functional group has not been introduced (in the case of the method (6), a porous membrane formed as in the method (6) except that the halogenated alkyl group included in the styrene monomer is not replaced with the weakly cationic functional group, such as a tertiary amino group, is used) is measured by the method described below.

The microparticle removal ratio R_{X} of a porous membrane prepared by, for example, any of the above methods (1) to (6) to which the weakly cationic functional group has been introduced is measured by the method described below.

The increase in the capability of the membrane to remove the microparticles is calculated using the following formula.

Increase in Capability to Remove Microparticles=(100−R_{O})/(100−R_{X})

[Method for Measuring Microparticle Removal Ratio]

A gold colloid (EMGC10 produced by BB International (average particle size: 10 nm, CV<10%)”) having a particle size of 10 nm and a concentration of 20,000 ppt is passed through the porous membrane under the following conditions. The concentration of the gold colloid in the permeate is measured by inductively coupled plasma mass spectrometry (ICP-MS) in order to calculate the removal ratio.

Membrane surface flux: 450 m³/m²/day

Temperature: 25° C.

The MF- or UF-membrane filtration unit including the weakly cationic functional group is preferably used in combination with an MF or UF membrane that does not include an ion-exchange group (hereinafter, may be referred to as “unmodified membrane”). Performing multi-stage membrane filtration by using the unmodified membrane in combination with the MF- or UF-membrane filtration unit including the weakly cationic functional group may further increase a capability to remove the microparticles due to the adsorptive activity of the MF- or UF-membrane and the molecular-sieve effect of the unmodified membrane.

The unmodified-membrane filtration unit may be disposed either upstream or downstream of the MF- or UF-membrane filtration unit including a weakly cationic functional group. The unmodified-membrane filtration unit may also be disposed both upstream and downstream of the MF- or UF-membrane filtration unit. It is preferable to dispose the unmodified-membrane filtration unit downstream of the MF- or UF-membrane filtration unit.

Arranging the unmodified-membrane filtration unit downstream of the MF- or UF-membrane filtration unit including a weakly cationic functional group enables microparticles that cannot be removed with the MF- or UF-membrane filtration unit including a weakly cationic functional group, which is disposed upstream of the unmodified-membrane filtration unit, and impurities detached from a filtration membrane included in the membrane filtration unit disposed upstream of the unmodified-membrane filtration unit to be effectively removed with the unmodified-membrane filtration unit disposed downstream of the MF- or UF-membrane filtration unit and, as a result, makes it possible to produce high-purity ultrapure water from which the microparticles have been removed at a high removal ratio.

Since the technique for efficiently cleaning the MF or UF membrane that does not include an ion-exchange group, which is included in the unmodified-membrane filtration unit disposed downstream of the MF- or UF-membrane filtration unit, has been established, it is possible to consistently continue the operation over a long period of time by arranging the unmodified-membrane filtration unit, which serves as a final membrane filtration unit, downstream of the MF- or UF-membrane filtration unit including the weakly cationic functional group and cleaning, as needed, the unmodified-membrane filtration unit disposed downstream of the MF- or UF-membrane filtration unit in order to recover the filtration performance of the unmodified-membrane filtration unit.

The unmodified membrane may be either an MF membrane or a UF membrane. In order to prevent the operating pressure of the unmodified membrane from being excessively increased and to effectively achieve the molecular-sieve effect, it is preferable to use an MF membrane having a pore size of about 0.02 to about 0.05 μm or a UF membrane having a molecular weight cut-off of about 1000 to about 20000. Various shapes of membranes such as a hollow fiber membrane and a flat membrane may be used as the unmodified membrane.

The device for removing microparticles contained in water according to the present invention is suitably used as a subsystem of an ultrapure-water production and supply system which produces ultrapure water from a primary pure water, in particular, as a device for removing microparticles which is disposed at the rear end of the subsystem. The device for removing microparticles contained in water according to the present invention may be disposed in a water-feed path through which the ultrapure water is fed from the subsystem to a point of use. The device for removing microparticles contained in water according to the present invention may also be used as a final microparticle-removal device disposed at a point of use.

The MF or UF membrane including a weakly cationic functional group according to the present invention is capable of removing microparticles having a size of 50 nm or less or, in particular, 10 nm or less at a high removal ratio due to the adsorptive activity of the weakly cationic functional group and hardly causes the detachment of the weakly cationic functional group, which results in the elution of the TOC components. Thus, the MF or UF membrane including a weakly cationic functional group according to the present invention is suitably used as a component of a microparticle-removal device constituting an ultrapure-water production and supply system.

An ultrapure-water production and supply system according to the present invention includes an ultrapure-water production apparatus including a subsystem that produces ultrapure water from primary pure water; a water-feed path through which the ultrapure water is fed from the subsystem to a point of use; and the above-described device for removing microparticles including nanoparticles contained in water according to the present invention, the device being disposed in the subsystem or the water-feed path.

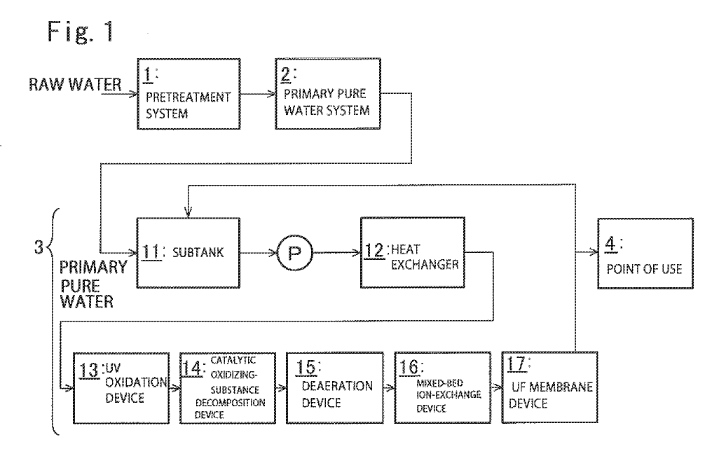

Components of the ultrapure-water production and supply system according to the present invention which are other than the device for removing microparticles including nanoparticles contained in water are not limited. For example, the ultrapure-water production and supply system according to the present invention may be the ultrapure-water production and supply system illustrated in FIG. 1 in which the UF membrane device 17 located at the rear end of the subsystem is replaced with the device for removing microparticles including nanoparticles contained in water according to the present invention.

The ultrapure-water production and supply system illustrated in FIG. 1 includes a pretreatment system 1, a primary pure water system 2, and a subsystem 3.

The pretreatment system 1 includes a coagulation device, a pressure flotation (sedimentation) device, a filtration device, and the like and removes suspended solids and colloidal substances contained in the raw water. The primary pure water system 2 includes a reverse osmosis (RO)-membrane separation device, a deaeration device, and an ion-exchange device (mixed-bed, two-bed-three-column, or four-bed-five-column) and removes ions and organic components contained in the raw water. The RO-membrane separation device removes salts and ionic, neutral, and colloidal TOC components. The ion-exchange device removes salts and TOC components that can be removed with an ion-exchange resin by adsorption or ion exchange. The deaeration device (nitrogen deaeration or vacuum deaeration) removes dissolved oxygen.

The primary pure water (i.e., pure water typically having a TOC concentration of 2 ppb or less) produced in the primary pure water system 2 is passed through a subtank 11, a pump P, a heat exchanger 12, an UV oxidation device 13, a catalytic oxidizing-substance decomposition device 14, a deaeration device 15, a mixed-bed deionization device (i.e., an ion-exchange device) 16, and a UF membrane device 17 for the separation of microparticles in this order. The resulting ultrapure water is fed to a point of use 4.

The UV oxidation device 13 is an UV oxidation device that emits an UV ray having a wavelength of about 185 nm, which is commonly used in an ultrapure-water production system, such as an UV oxidation device including a low-pressure mercury lamp. The UV oxidation device 13 decomposes the TOC components contained in the primary pure water into organic acids and, finally, into CO₂. An excess UV ray emitted from the UV oxidation device 13 converts water into H₂O₂.

The water treated in the UV oxidation device is passed into the catalytic oxidizing-substance decomposition device 14. Examples of the oxidizing-substance decomposition catalyst included in the catalytic oxidizing-substance decomposition device 14 include the noble metal catalysts known as redox catalysts, such as palladium (Pd) compounds (e.g., metal palladium, palladium oxide, and palladium hydroxide) and platinum (Pt). Among the above catalysts, in particular, palladium catalysts are suitably used since they have a high reducing power.

The catalytic oxidizing-substance decomposition device 14 efficiently decomposes and removes H₂O₂ generated in the UV oxidation device 13 and other oxidizing substances with the catalyst. Since the decomposition of H₂O₂ produces water but hardly produce oxygen in contrast to the decomposition of H₂O₂ with an anion-exchange resin or an active carbon, it does not increase the amount of DO.

The water treated in the catalytic oxidizing-substance decomposition device 14 is passed into the deaeration device 15. The deaeration device 15 may be a vacuum deaeration device, a nitrogen deaeration device, or a membrane deaeration device. The deaeration device 15 efficiently removes DO and CO₂ contained in water.

The water treated in the deaeration device 15 is passed into a mixed-bed ion-exchange device 16. The mixed-bed ion-exchange device 16 is a nonregenerative mixed-bed ion-exchange device including an anion-exchange resin and a cation-exchange resin that are mixed in accordance with ionic load. The mixed-bed ion-exchange device 16 removes the cations and anions contained in water and increases the purity of the water.

The water treated in the mixed-bed ion-exchange device 16 is passed into the UF membrane device 17. The UF membrane device 17 removes the microparticles contained in water, such as the microparticles discharged from an ion-exchange resin included in the mixed-bed ion-exchange device 16.

The device for removing microparticles including nanoparticles contained in water according to the present invention may also be disposed in a water-feed path through which the ultrapure water is fed from the UF membrane device 17 to a point of use 4.

The device for removing microparticles including nanoparticles contained in water according to the present invention may also be disposed inside a point of use. As described above, a mini-subsystem that serves as a point-of-use polisher may be disposed immediately upstream or the inside of a cleaning machine used for cleaning semiconductors and electronic materials, the mini-subsystem including the device for removing microparticles contained in water according to the present invention which is disposed at the rear end of the mini-subsystem.

The structure of the ultrapure-water production and supply system according to the present invention is not limited to that illustrated in FIG. 1. For example, the catalytic oxidizing-substance decomposition device 14 and the deaeration device 15 may be omitted. In such a case, the water treated by UV irradiation in the UV oxidation device 13 may be directly introduced to the mixed-bed deionization device 16. The catalytic oxidizing-substance decomposition device 14 may be replaced with an anion-exchange column.

An RO-membrane separation device may be optionally disposed downstream of the mixed-bed ion-exchange device. The ultrapure-water production and supply system according to the present invention may further include a device that decomposes urea and other TOC components contained in the raw water by pyrolysis under an acidic condition of a pH of 4.5 or less in the presence of an oxidizing agent and subsequently performs deionization. The UV oxidation device, the mixed-bed ion-exchange device, the deaeration device, or the like may be disposed at multiple stages.

The structures of the pretreatment system 1 and the primary pure water system 2 are also not limited to the above-described structures and may include any combination of devices.

### EXAMPLES

The present invention is described more specifically below, with reference to Test examples instead of Examples and Comparative examples.

### Test Example I

The test membranes described below were each subjected to the filtration tests (1) to (3) below. Table 1 shows the results. The filtration tests were all conducted with a pressure difference of 66 kPa at a water temperature of 25° C.

<Test Membranes>

Test No. I-1 (Comparative example): Mixed cellulose ester membrane having a pore size of 0.1 μm (“JCWP” produced by Millipore)

Test No. I-2 (Comparative example): Hydrophilic polytetrafluoroethylene membrane having a pore size of 0.1 μm (“JVWP” produced by Millipore)

Test No. I-3 (Comparative example): Polyketone membrane having a pore size of 0.1 μm

Test No. I-4 (Invention example): Polyketone membrane having a pore size of 0.1 μm to which a dimethylamino group had been introduced, which was prepared by immersing a polyketone membrane formed by a publicly known method (e.g., JP 2013-76024 A or WO 2013-035747 A) in an aqueous N,N-dimethylamino-1,3-propylamine solution containing a small amount of acid, heating the immersed polyketone membrane, and subsequently cleaning the polyketone membrane with water and methanol, and drying the polyketone membrane.

<Filtration Tests>

(1) With the test membrane, 500 mL of pure water was subjected to suction filtration. The amount of time required for the filtration (i.e., the filtration time) was measured.

(2) A 1-mg/L aqueous xanthan gum solution (i.e., a sugar solution) was subjected to suction filtration with the test membrane, and the amount of time required for the filtration (i.e., the filtration time) was measured.

(3) With the test membrane, 15 mL of an aqueous dispersion containing polystyrene latex particles having a size of 120 nm at a concentration of 330,000 ppt was subjected to suction filtration. The turbidity of the permeate was measured with a Portable Turbidimeter 2100Q (produced by Hach Ultra).

The ratio (T₁/T₀) of the filtration time (T₁) measured in the filtration test (2) to the filtration time (T₀) measured in the filtration test (1) was calculated and used for evaluating susceptibility to contamination. The lower the ratio T₁/T₀, the less the susceptibility to contamination.

TABLE 1

| | | Filtration time [sec] | | | |
|---|---|---|---|---|---|
| | | Pure | Sugar | | |
| Test | | water | solution | | Turbidity |
| No. | Test membrane | (T₀) | (T₁) | T₁/T₀ | [NTU] |
| I - 1 | Mixed cellulose ester | 178.1 | 242.8 | 1.36 | 0.29 |
| | membrane | | | | |
| I - 2 | Polytetrafluoroethylene | 36.2 | 65.3 | 1.80 | 116 |
| | membrane | | | | |
| I - 3 | Polyketone membrane | 59.2 | 64.1 | 1.08 | 15.3 |
| I - 4 | Dimethylamino-group- | 62.9 | 72.6 | 1.15 | 0.14 |
| | modified polyketone | | | | |
| | membrane | | | | |

The above test results confirm the following facts.

The polyketone membrane had a higher permeability than the mixed cellulose ester membrane. Furthermore, the change in the filtration time (T₁/T₀) which occurred when the sugar solution was filtered through the polyketone membrane instead of the pure water was small compared with the cases where the mixed cellulose ester membrane or the polytetrafluoroethylene membrane was used. That is, the polyketone membrane had low susceptibility to contamination.

A comparison between the turbidities of the permeates prepared by filtering the aqueous polystyrene latex dispersion through the respective test membranes confirms that the polyketone membrane including a dimethylamino group had a highest capability to remove the microparticles.

### Test Example II

The test membranes described below were each subjected to the filtration tests (1) to (3) below. Table 2 shows the results.

In all of the filtration tests, the concentration of the gold colloid passed through the test membrane was 20,000 ppt, the water temperature was 25° C., and the flux of the test membrane was 450 m³/m²/day. The UF membrane used in the filtration test (3) had a membrane flux of 10 m³/m²/day.

<Test Membranes>

Test No II-1 (Comparative example): Polyketone membrane having a pore size of 0.1 μm

Test No. II-2 (Invention example): Polyketone membrane having a pore size of 0.1 μm to which a dimethylamino group had been introduced, which was prepared by immersing a polyketone membrane formed by a publicly known method (e.g., JP 2013-76024 A or WO 2013-035747 A) in an aqueous N,N-dimethylamino-1,3-propylamine solution containing a small amount of acid, heating the immersed polyketone membrane, and subsequently cleaning the polyketone membrane with water and methanol, and drying the polyketone membrane.

<Filtration Tests>

(1) A gold colloid (“EMGC50 (average particle size: 50 nm, CV<8%)” produced by BB International) having a particle size of 50 nm was passed through the test membrane. The concentration of the gold colloid in the permeate was measured in order to calculate the removal ratio.

(2) A gold colloid (“EMGC10 (average particle size: 10 nm, CV<10%)” produced by BB International) having a particle size of 10 nm was passed through the test membrane. The concentration of the gold colloid in the permeate was measured in order to calculate the removal ratio.

The concentration of the gold colloid was measured by ICP-MS. The same applied to Test Example III below.

(3) A UF membrane having a nominal molecular weight cut-off of 6,000 (defined on the basis of an insulin rejection ratio of 90%) was disposed downstream of the test membrane. A gold colloid having a particle size of 10 nm, which was the same as that used in (2) above, was sequentially passed through the test membrane and the UF membrane. The concentration of the gold colloid in the permeate was measured in order to calculate the removal ratio.

TABLE 2

| | | | | | | 10-nm Gold colloid (with | |
|---|---|---|---|---|---|---|---|
| | | 50-nm Gold colloid | | 10-nm Gold colloid | | UF membrane) | |
| | | Concentration | Removal | Concentration | Removal | Concentration | Removal |
| | | in permeate | ratio | in permeate | ratio | in permeate | ratio |
| Test No. | Membrane | (ppt) | (%) | (ppt) | (%) | (ppt) | (%) |
| II-1 | Polyketone membrane | 420 | 97.9 | 12,000 | 40 | 0.2 | 99.999 |
| II-2 | Dimethylamino-group- | 1 | 99.995 | 2 | 99.99 | <0.2 | >99.999 |
| | modified polyketone | | | | | | |
| | membrane | | | | | | |

The above test results confirm the following facts.

The dimethylamino-group-modified polyketone membrane achieved a removal ratio of 99.99% even in the case where the gold colloid having a particle size of 10 nm was used. This confirms that a membrane including a weakly anionic functional group is capable of removing the microparticles. Moreover, using the membrane including a weakly anionic functional group in combination with the UF membrane having a molecular weight cut-off of about 6,000, which has the molecular-sieve effect, further increased the microparticle removal ratio due to the adsorptive activity and the molecular-sieve effect.

The above results confirm that introducing a weakly anionic functional group, such as a dimethylamino group, to a polyketone membrane enhances the capability of the polyketone membrane to remove the microparticles and that using the polyketone membrane in combination with such a UF membrane further enhances the removal capability.

The increase in the capability of the above dimethylamino-group-modified polyketone membrane to remove the microparticles was 6000 ((100−R_{O})/(100−R_{X})=(100−40)/(100−99.99)).

### Test Example III

The test membranes described below were each subjected to the filtration tests (1) and (2) below. Table 3 shows the results.

In all of the filtration tests, the concentration of the gold colloid passed through the test membrane was 20,000 ppt, the water temperature was 25° C., and the flux of the test membrane was 50 m³/m²/day. The UF membrane used in the filtration test (2) had a membrane flux of 10 m³/m²/day.

<Test Membranes>

Test No III-1 (Comparative example): Two mixed cellulose ester membranes having a pore size of 0.1 μm (“VCWP” produced by Millipore) which were stacked on top of each other.

Test No. III-2 (Invention example): Membrane to which a weakly cationic functional group had been introduced, which was prepared by interposing pulverized particles of a weak-anion-exchange resin (“HWA50U” produced by Mitsubishi Chemical Corporation) between two mixed cellulose ester membranes “VCWP” having a pore size of 0.1 μm.

<Filtration Tests>

(1) A gold colloid (“EMGC100 (average particle size: 10 nm, CV<10%)” produced by BB International) having a particle size of 10 nm was passed through the test membrane. The concentration of the gold colloid in the permeate was measured in order to calculate the removal ratio.

(2) A UF membrane having a nominal molecular weight cut-off of 6,000 (defined on the basis of an insulin rejection ratio of 90%) was disposed downstream of the test membrane. A gold colloid having a particle size of 10 nm, which was the same as that used in (1) above, was sequentially passed through the test membrane and the UF membrane. The concentration of the gold colloid in the permeate was measured in order to calculate the removal ratio.

TABLE 3

| | | | | 10-nm Gold colloid | |
|---|---|---|---|---|---|
| | | 10-nm Gold colloid | | (with UF membrane) | |
| | | Concen- | | Concen- | |
| | | tration in | Removal | tration in | Removal |
| Test | | permeate | ratio | permeate | ratio |
| No. | Membrane | (ppt) | (%) | (ppt) | (%) |
| III - 1 | Mixed cellulose | 20,000 | 0 | 1 | 99.995 |
| | ester membrane | | | | |
| III - 2 | Weakly cationic- | 1,900 | 90.5 | <0.2 | >99.999 |
| | group-containing | | | | |
| | mixed cellulose | | | | |
| | ester membrane | | | | |

The above test results confirm that introducing the weakly cationic functional group to the mixed cellulose ester membrane having a pore diameter of 0.1 μm enhanced the capability of the mixed cellulose ester membrane to remove the microparticles and that using the mixed cellulose ester membrane in combination with the UF membrane further enhanced the removal capability.

### Test Example IV

Ultrapure water (TOC: 0.05 ppb or less) was passed through each of the test membranes described below at 25° C. at a membrane flux of 70 m³/m²/day. The TOC concentration in each of the permeates was measured with a wet oxidation/NDIR TOC analyzer over time. Table 4 shows the results.

<Test Membranes>

Test No. IV-1 (Comparative example): Two mixed cellulose ester membranes having a pore size of 0.1 μm (“VCWP” produced by Millipore) which were stacked on top of each other.

Test No. IV-2 (Comparative example): Membrane to which a strongly cationic functional group had been introduced, which was prepared by interposing pulverized particles of a strong-anion-exchange resin (“SAT15L” produced by Mitsubishi Chemical Corporation) between two mixed cellulose ester membranes “VCWP” having a pore size of 0.1 μm.

Test No. IV-3 (Invention example): Membrane to which a weakly cationic functional group had been introduced, which was prepared by interposing pulverized particles of a weak-anion-exchange resin (“HWA50U” produced by Mitsubishi Chemical Corporation) between two mixed cellulose ester membranes “VCWP” having a pore size of 0.1 μm.

TABLE 4

| | | TOC in permeate after lapse of certain | | | |
|---|---|---|---|---|---|
| | | period of time since water started to | | | |
| Test | | pass through test membrane(ppb) | | | |
| No. | Membrane | 0.5 hr | 1 hr | 6 hr | 24 hr |
| IV - 1 | Mixed cellulose | <1 | <1 | <1 | <1 |
| | ester membrane | | | | |
| IV - 2 | Strongly cationic- | 20 | 10 | 5 | 2 |
| | group-containing | | | | |
| | mixed cellulose | | | | |
| | ester membrane | | | | |
| IV - 3 | Weakly cationic- | 5 | 2 | <1 | <1 |
| | group-containing | | | | |
| | mixed cellulose | | | | |
| | ester membrane | | | | |

The results shown in Table 4 confirm that the introduction of the cationic functional group increased the TOC concentration in the permeate immediately after the water started to pass through the test membrane and that it is not preferable to use a strongly cationic functional group, since the introduction of the strongly cationic functional group significantly increased the TOC concentration in the permeate. In contrast, although the introduction of the weakly cationic functional group also caused the elution of the TOC components, the degree of the elution of the TOC components was small compared with the case where the strongly cationic functional group was used. Specifically, the elution of the TOC components became negligible after a lapse of six hours since the water started to pass through the test membrane.

### Test Example V

A test for confirming the stability of a strong-anion-exchange group including a quaternary ammonium group was conducted. Specifically, a strong-anion-exchange resin: SA20A (produced by Mitsubishi Chemical Corporation) was held at 50° C., and the total ion-exchange capacity and the salt splitting capacity of the strong-anion-exchange resin were determined by the following methods (see DIAION: Manual of Ion Exchange Resins and Synthetic Adsorbent, Volume 1, Mitsubishi Chemical Corporation, pp. 132-140). Table 5 shows the changes in the above properties over time.

<Salt Splitting Capacity>

After the resin had been completely converted into the OH-form with an aqueous NaOH solution, an excessively large amount of aqueous NaCl solution was passed through the resin. The amount of NaOH liberated from the resin was measured.

<Total Ion-Exchange Capacity>

An aqueous HCl solution was passed through the resin that had been used for the measurement of salt splitting capacity, and the amount of HCl that reacted with the resin was measured in order to determine weak-base exchange capacity. Note that, the following equation holds: Total ion-exchange capacity=Salt splitting capacity+Weak-base-exchange capacity

TABLE 5

| Time (hr) | 0 | 8 | 24 | 102 | 177 |
|---|---|---|---|---|---|
| Total ion-exchange | 1.36 | 1.36 | 1.36 | 1.36 | 1.33 |
| capacity | | | | | |
| (meq/mL-resin) | | | | | |
| Salt splitting capacity | 1.34 | 1.30 | 1.24 | 1.13 | 1.08 |
| (meq/mL-resin) | | | | | |

The above test is an accelerated test in which the changes in total ion-exchange capacity and salt splitting capacity over time were determined.

The results shown in Table 5 confirm that the change in total ion-exchange capacity over time was negligible, while the change in salt splitting capacity over time was large. This means that a quaternary amine was converted into a tertiary amine because of the chemical instability thereof, while the tertiary amine was chemically stable.

Although the present invention has been described in detail with reference to a particular embodiment, it is apparent to a person skilled in the art that various modifications can be made therein without departing from the spirit and scope of the present invention.

The present application is based on Japanese Patent Application No. 2015-033002 filed on Feb. 23, 2015, which is incorporated herein by reference in its entirety.

### REFERENCE SIGNS LIST

1 PRETREATMENT SYSTEM
2 PRIMARY PURE WATER SYSTEM
3 SUBSYSTEM
4 POINT OF USE
17 UF MEMBRANE DEVICE

1. A device for removing microparticles contained in water in a process for producing ultrapure water, the device comprising a membrane filtration unit including a microfiltration or ultrafiltration membrane including a weakly cationic functional group.

2. The device for removing microparticles contained in water according to claim 1, wherein the microfiltration or ultrafiltration membrane including a weakly cationic functional group is prepared by introducing a weakly cationic functional group to a polyketone membrane.

3. The device for removing microparticles contained in water according to claim 1, wherein the weakly cationic functional group is a tertiary amino group.

4. The device for removing microparticles contained in water according to claim 1, the device further comprising another membrane filtration unit disposed upstream or downstream of the membrane filtration unit including the microfiltration or ultrafiltration membrane including a weakly cationic functional group, the other membrane filtration unit including a microfiltration or ultrafiltration membrane that does not include an ion-exchange group.

5. The device for removing microparticles contained in water according to claim 1, wherein the microparticles are nanoparticles having a size of 10 nm or less.

6. The device for removing microparticles contained in water according to claim 1, the device being disposed in a subsystem included in an ultrapure-water production apparatus, the subsystem producing ultrapure water from primary pure water; in a water-feed path through which the ultrapure water is fed from the subsystem to a point of use; or at the point of use.

7. An ultrapure-water production and supply system comprising an ultrapure-water production apparatus including a subsystem that produces ultrapure water from primary pure water; a water-feed path through which the ultrapure water is fed from the subsystem to a point of use; and the device for removing microparticles contained in water according to claim 1, the device being disposed in the subsystem or the water-feed path.
